(19) United States
(12) Patent Application Publication
(10) Pub. No.: US 2026/0135018 A1
(43) Pub. Date: May 14, 2026

(54) OVERHEAT PROTECTION TYPE HIGH-TEMPERATURE RESISTANT CABLE

(71) Applicant: Jiangsu Pucao Technology Co., Ltd., Yixing (CN)

(72) Inventors: Lihui RUI, Yixing (CN); Lichun RUI, Yixing (CN); Xianliang WU, Yixing (CN); Yong WU, Yixing (CN)

(73) Assignee: Jiangsu Pucao Technology Co., Ltd., Yixing (CN)

(21) Appl. No.: 19/386,116

(22) Filed: Nov. 11, 2025

(30) Foreign Application Priority Data
Nov. 12, 2024 (CN) 202411605978.0

(51) Int. Cl. H01B 7/42; H01B 7/29

(52) U.S. Cl. CPC H01B 7/423; H01B 7/292

(57) ABSTRACT

An overheat protection type high-temperature resistant cable includes a high-temperature resistant cable body and a heat-resistant cable maintenance station, the high-temperature resistant cable body includes a cable core, an isolation layer sleeved on an outer end of the cable core, an inner liquid cooling layer sleeved on an outer end of the isolation layer, an outer liquid cooling layer disposed on an outer side of the inner liquid cooling layer, and a protective outer layer sleeved on an outer end of the outer liquid cooling layer. A heat-resistant protection system including a heat-resistant protection processing unit is provided in the heat-resistant cable maintenance station, an input end of the heat-resistant protection processing unit is connected to an inner end triggering acquisition unit, an outer end triggering acquisition unit, a liquid cooling parameter acquisition unit, and a cable parameter acquisition unit, and an output end of the heat-resistant protection processing unit is connected to a liquid cooling adjustment unit and a protection data transmission unit.

### CROSS-REFERENCE TO RELATED APPLICATIONS

This application claims priority to Chinese Patent Application No. 202411605978.0, filed on November 12, 2024, which is incorporated herein by reference in its entirety.

### TECHNICAL FIELD

The present disclosure relates to a high-temperature resistant cable, and in particular, to an overheat protection type high-temperature resistant cable for use in the field of cables.

### BACKGROUND

A high-temperature resistant cable is a specially designed cable capable of maintaining stable performance in high-temperature environments and is widely used in various high-temperature applications and equipment. To ensure the stability of the high-temperature resistant cable in high-temperature environments, the high-temperature resistant cable is integrated with liquid cooling technology to enhance the cooling effect on the high-temperature resistant cable and reduce performance degradation caused by high temperatures.

The application of liquid cooling technology in high-temperature resistant cables primarily involves providing dedicated cooling channels inside the cable. Cooling liquid is circulated through these cooling channels to carry away heat, thereby effectively reducing the operating temperature of the cable in high-temperature environments.

Currently, the circulation of the cooling liquid in high-temperature resistant cables is constant. When the high-temperature resistant cable experiences a sudden change in the external or internal environment leading to a temperature increase, the heat dissipation circulation cannot be adjusted based on the environmental change factors. This limitation not only reduces the functionality of the liquid cooling technology applied in the high-temperature resistant cable and increases energy consumption, but also causes overheating damage to the high-temperature resistant cable, reducing its operational stability and safety.

### SUMMARY

Aiming at the prior art described above, the technical problem to be solved by the present disclosure is how to promptly address sudden changes in the external or internal environment of a high-temperature resistant cable that result in a temperature increase in the cable, thereby providing overheat protection for the high-temperature resistant cable.

To solve the above problem, the present disclosure provides an overheat protection type high-temperature resistant cable, wherein the cable includes a high-temperature resistant cable body and a heat-resistant cable maintenance station configured to cooperate with the high-temperature resistant cable body, wherein the high-temperature resistant cable body includes a cable core, an isolation layer fixedly sleeved on an outer end of the cable core, an inner liquid cooling layer fixedly sleeved on an outer end of the isolation layer, an outer liquid cooling layer disposed on an outer side of the inner liquid cooling layer, and a protective outer layer fixedly sleeved on an outer end of the outer liquid cooling layer;

an inner heat sensing sleeve is fixedly sleeved on an outer end of the inner liquid cooling layer, a bidirectional isolation sleeve is fixedly sleeved on an outer end of the inner heat sensing sleeve, an outer heat sensing sleeve is fixedly sleeved on an outer end of the bidirectional isolation sleeve, and an outer end of the outer heat sensing sleeve is fixedly connected to the outer liquid cooling layer; wherein a plurality of triggering posts are embedded in the bidirectional isolation sleeve, each of the triggering posts has one end away from the cable core extending into the outer heat sensing sleeve and configured to cooperate with the outer heat sensing sleeve; and each of the triggering posts has another end close to the cable core extending into the inner heat sensing sleeve and configured to cooperate with the inner heat sensing sleeve;

a heat-resistant protection system is provided in the heat-resistant cable maintenance station, wherein the heat-resistant protection system includes a heat-resistant protection processing unit, an input end of the heat-resistant protection processing unit is connected to an inner end triggering acquisition unit, an outer end triggering acquisition unit, a liquid cooling parameter acquisition unit, and a cable parameter acquisition unit, and an output end of the heat-resistant protection processing unit is connected to a liquid cooling adjustment unit and a protection data transmission unit; and

an input end of the inner end triggering acquisition unit is in signal communication with the outer heat sensing sleeve, an input end of the outer end triggering acquisition unit is in signal communication with the inner heat sensing sleeve, respective input ends of the liquid cooling parameter acquisition unit and the cable parameter acquisition unit are each in signal communication with a signal input port provided on the heat-resistant cable maintenance station, an output end of the liquid cooling adjustment unit is in signal communication with a liquid cooling circulation structure provided at a rear side of the heat-resistant cable maintenance station, the liquid cooling circulation structure is in communication with and configured to cooperate with the outer liquid cooling layer and the inner liquid cooling layer respectively, and an output end of the protection data transmission unit is in signal communication with a signal output port provided on the heat-resistant cable maintenance station.

In the aforementioned overheat protection type high-temperature resistant cable, when a sudden temperature change occurs externally or internally to the high-temperature resistant cable body, the cable is configured to promptly generate triggering induction that initiates liquid cooling adjustment for overheat protection, reducing damage to the high-temperature resistant cable body caused by overheating, and promoting the operational stability and safety of the high-temperature resistant cable body in high-temperature environments.

As a supplement to the present disclosure, an outer thermal deformation cavity is formed in the outer heat sensing sleeve, an outer triggering patch is fixedly connected to an inner wall on a side of the outer thermal deformation cavity away from the cable core, the outer triggering patch is configured to cooperate with one end of each of the triggering posts away from the cable core, and the input end of the inner end triggering acquisition unit is in signal communication with the outer triggering patch.

As a supplement to the present disclosure, an inner thermal deformation cavity is formed in the inner heat sensing sleeve, an inner triggering patch is fixedly connected to an inner wall on a side of the inner thermal deformation cavity close to the cable core, the inner triggering patch is configured to cooperate with one end of each of the triggering posts close to the cable core, and the input end of the outer end triggering acquisition unit is in signal communication with the inner triggering patch.

As a further improvement of the present disclosure, the outer thermal deformation cavity is filled with an outer thermal deformation medium, and at normal temperature, the fill level of the outer thermal deformation medium in the outer thermal deformation cavity is 50% to 60%.

As a still further improvement of the present disclosure, the inner thermal deformation cavity is filled with an inner thermal deformation medium, and at normal temperature, the fill level of the inner thermal deformation medium in the inner thermal deformation cavity is 50% to 60%.

As yet a further improvement of the present disclosure, a buffer sensing cavity is formed in each of the triggering posts, a triggering core block is fixedly connected to a middle portion of the buffer sensing cavity, an overheating conduction post is embedded in each of an inner wall of the buffer sensing cavity close to the cable core and an inner wall of the buffer sensing cavity away from the cable core, and ends of the two overheating conduction posts close to each other extend into the buffer sensing cavity and are configured to cooperate with the triggering core block.

As a supplement to the yet further improvement of the present disclosure, an outer end of each of the overheating conduction posts is fixedly connected to a retaining ring located in the buffer sensing cavity, the retaining ring is slidably engaged with an inner wall of the buffer sensing cavity, one end of the retaining ring close to the triggering core block is fixedly connected to an elastic reset element sleeved on an outer side of each of the overheating conduction posts, and one end of the elastic reset element close to the triggering core block is fixedly connected to the triggering core block.

As another improvement of the present disclosure, the input end of the heat-resistant protection processing unit is further connected to an inner end heat accumulation feedback unit and an outer end heat accumulation feedback unit, respective input ends of the inner end heat accumulation feedback unit and the outer end heat accumulation feedback unit are in signal communication with the triggering core block, the output end of the heat-resistant protection processing unit is connected to a heat accumulation alarm unit, and an output end of the heat accumulation alarm unit is in signal communication with an alarm provided on the heat-resistant cable maintenance station.

In summary, through the cooperation of the outer heat sensing sleeve, the bidirectional isolation sleeve, the inner heat sensing sleeve, the triggering posts, and the heat-resistant protection system, during the use of the high-temperature resistant cable body, on one hand, the cable maintains control over internal and external temperatures of the high-temperature resistant cable body, reducing the impact of external temperature or internal operating temperature on the high-temperature resistant cable body, and promoting the operational stability and safety of the high-temperature resistant cable body; on the other hand, the cable is configured to promptly generate triggering induction in response to a sudden temperature change occurring externally or internally to the high-temperature resistant cable body. This configuration provides real-time monitoring and also enables timely protection for the high-temperature resistant cable body against overheating. This arrangement enhances the effectiveness of the outer liquid cooling layer and the inner liquid cooling layer, improves the timeliness of response of the outer liquid cooling layer and the inner liquid cooling layer to internal and external temperature variations of the high-temperature resistant cable body, and reduces damage to the high-temperature resistant cable body caused by overheating. This configuration ensures the service life of the high-temperature resistant cable body while promoting the operational stability and safety of the high-temperature resistant cable body in high-temperature environments. Furthermore, targeted regulation of the liquid cooling circulation for the high-temperature resistant cable body is achieved based on overheating factors. This promotes the heat dissipation effect, reduces damage caused by temperature to the high-temperature resistant cable body, provides effective overheat protection, and also effectively reduces energy consumption, enhancing the environmental friendliness of the high-temperature resistant cable body in application.

### BRIEF DESCRIPTION OF THE DRAWINGS

FIG. 1 is an axonometric view showing the cooperation between the high-temperature resistant cable body and the heat-resistant cable maintenance station according to Embodiment 1 and Embodiment 2 of the present disclosure;

FIG. 2 is a control logic diagram of the heat-resistant protection system according to Embodiment 1 and Embodiment 2 of the present disclosure;

FIG. 3 is an axonometric cross-sectional view of the high-temperature resistant cable body according to Embodiment 1 and Embodiment 2 of the present disclosure;

FIG. 4 is a left-side cross-sectional view of the high-temperature resistant cable body under a normal liquid cooling state according to Embodiment 1 and Embodiment 2 of the present disclosure;

FIG. 5 is a front cross-sectional view of the high-temperature resistant cable body under the normal liquid cooling state according to Embodiment 1 and Embodiment 2 of the present disclosure;

FIG. 6 is a left-side cross-sectional view of the high-temperature resistant cable body under an internal overheating state according to Embodiment 1 and Embodiment 2 of the present disclosure;

FIG. 7 is a front cross-sectional view of the high-temperature resistant cable body under the internal overheating state according to Embodiment 1 and Embodiment 2 of the present disclosure;

FIG. 8 is a left-side cross-sectional view of the high-temperature resistant cable body under an external overheating state according to Embodiment 1 and Embodiment 2 of the present disclosure;

FIG. 9 is a front cross-sectional view of the high-temperature resistant cable body under the external overheating state according to Embodiment 1 and Embodiment 2 of the present disclosure;

FIG. 10 is a partial cross-sectional view of a triggering post in the high-temperature resistant cable body under the normal liquid cooling state according to Embodiment 2 of the present disclosure;

FIG. 11 is a partial cross-sectional view of the triggering post in the high-temperature resistant cable body under a persistent internal overheating state according to Embodiment 2 of the present disclosure; and

FIG. 12 is a partial cross-sectional view of the triggering post in the high-temperature resistant cable body under a persistent external overheating state according to Embodiment 2 of the present disclosure.

### DETAILED DESCRIPTION OF THE EMBODIMENTS

The following provides a detailed description of two embodiments of the present disclosure with reference to the accompanying drawings.

### Embodiment 1

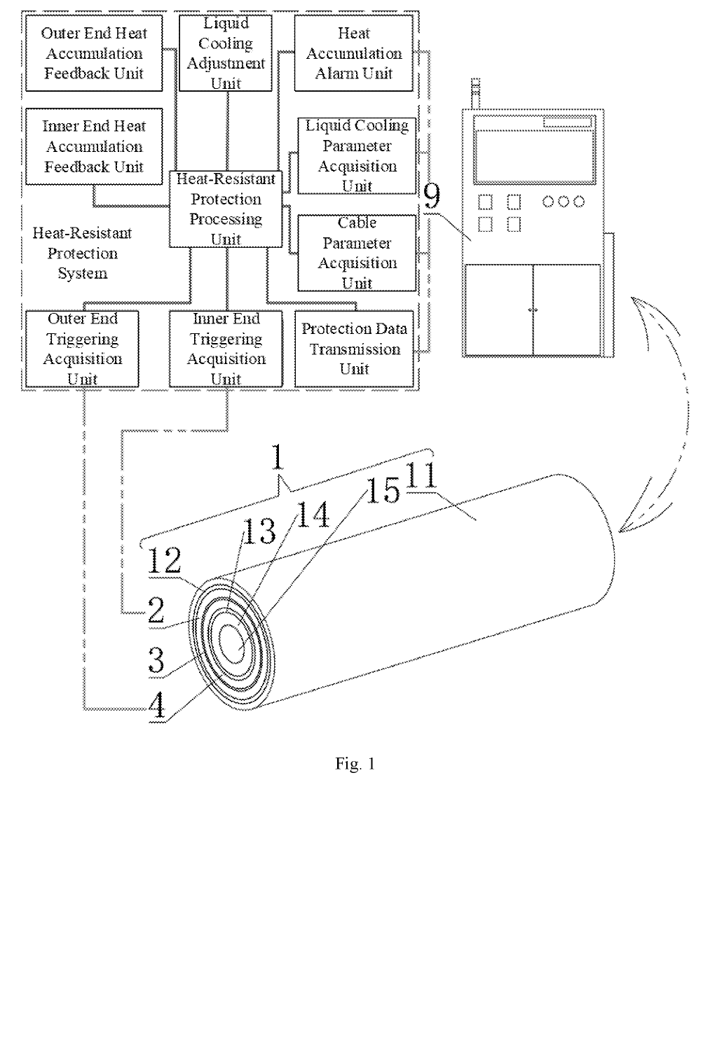

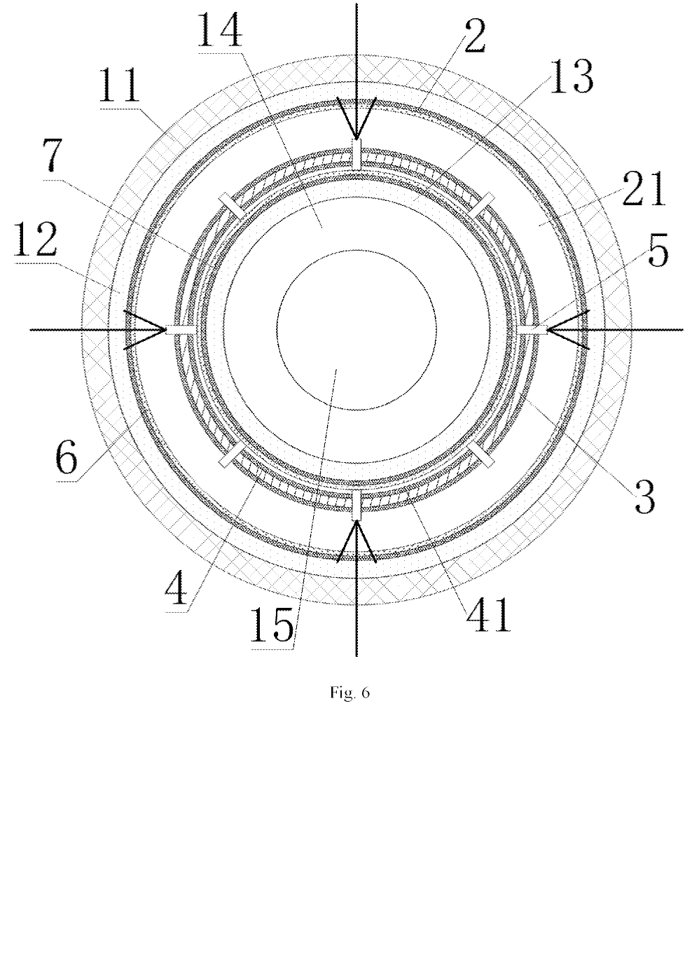

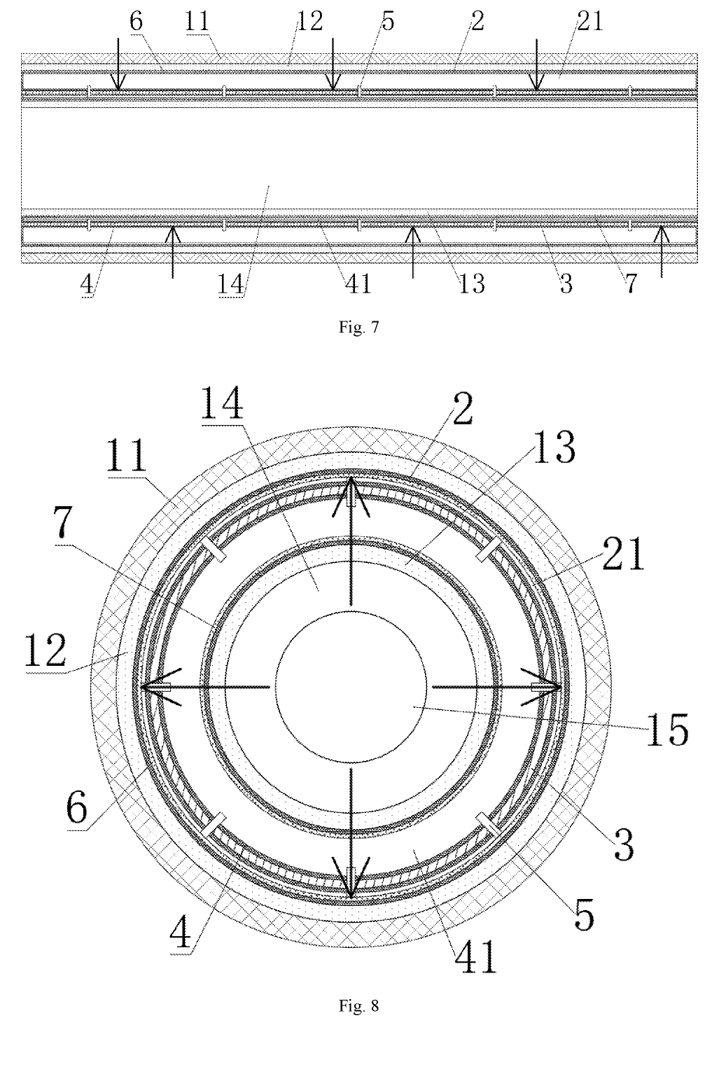

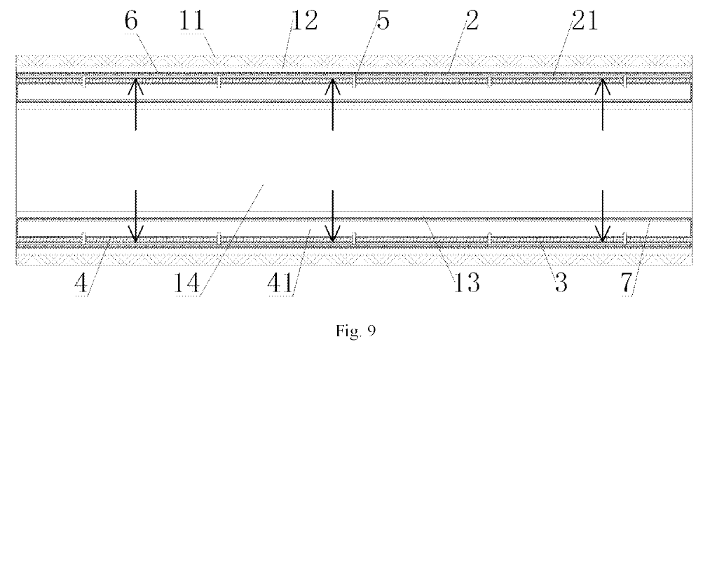

FIGS. 1 to 9 show an overheat protection type high-temperature resistant cable. The cable includes a high-temperature resistant cable body 1 and a heat-resistant cable maintenance station 9 configured to cooperate with the high-temperature resistant cable body 1, wherein the high-temperature resistant cable body 1 includes a cable core 15, an isolation layer 14 fixedly sleeved on an outer end of the cable core 15, an inner liquid cooling layer 13 fixedly sleeved on an outer end of the isolation layer 14, an outer liquid cooling layer 12 disposed on an outer side of the inner liquid cooling layer 13, and a protective outer layer 11 fixedly sleeved on an outer end of the outer liquid cooling layer 12.

An inner heat sensing sleeve 4 is fixedly sleeved on an outer end of the inner liquid cooling layer 13, a bidirectional isolation sleeve 3 is fixedly sleeved on an outer end of the inner heat sensing sleeve 4, an outer heat sensing sleeve 2 is fixedly sleeved on an outer end of the bidirectional isolation sleeve 3, and an outer end of the outer heat sensing sleeve 2 is fixedly connected to the outer liquid cooling layer 12; wherein a plurality of triggering posts 5 are embedded in the bidirectional isolation sleeve 3, each of the triggering posts 5 has one end away from the cable core 15 extending into the outer heat sensing sleeve 2 and configured to cooperate with the outer heat sensing sleeve 2; and each of the triggering posts 5 has another end close to the cable core 15 extending into the inner heat sensing sleeve 4 and configured to cooperate with the inner heat sensing sleeve 4.

A heat-resistant protection system is provided in the heat-resistant cable maintenance station 9, wherein the heat-resistant protection system includes a heat-resistant protection processing unit, an input end of the heat-resistant protection processing unit is connected to an inner end triggering acquisition unit, an outer end triggering acquisition unit, a liquid cooling parameter acquisition unit, and a cable parameter acquisition unit, and an output end of the heat-resistant protection processing unit is connected to a liquid cooling adjustment unit and a protection data transmission unit.

An input end of the inner end triggering acquisition unit is in signal communication with the outer heat sensing sleeve 2, an input end of the outer end triggering acquisition unit is in signal communication with the inner heat sensing sleeve 4, respective input ends of the liquid cooling parameter acquisition unit and the cable parameter acquisition unit are each in signal communication with a signal input port provided on the heat-resistant cable maintenance station 9, an output end of the liquid cooling adjustment unit is in signal communication with a liquid cooling circulation structure provided at a rear side of the heat-resistant cable maintenance station 9, the liquid cooling circulation structure is in communication with and configured to cooperate with the outer liquid cooling layer 12 and the inner liquid cooling layer 13 respectively, and an output end of the protection data transmission unit is in signal communication with a signal output port provided on the heat-resistant cable maintenance station 9. Through the cooperation of the outer heat sensing sleeve 2, the bidirectional isolation sleeve 3, the inner heat sensing sleeve 4, the triggering posts 5, and the heat-resistant protection system, during the use of the high-temperature resistant cable body 1, on one hand, the cable maintains control over internal and external temperatures of the high-temperature resistant cable body 1, reducing the impact of external temperature or internal operating temperature on the high-temperature resistant cable body 1, and promoting the operational stability and safety of the high-temperature resistant cable body 1; on the other hand, the cable is configured to promptly generate triggering induction in response to a sudden temperature change occurring externally or internally to the high-temperature resistant cable body 1. This configuration provides real-time monitoring and also enables timely protection for the high-temperature resistant cable body 1 against overheating. This arrangement enhances the effectiveness of the outer liquid cooling layer 12 and the inner liquid cooling layer 13, improves the timeliness of response of the outer liquid cooling layer 12 and the inner liquid cooling layer 13 to internal and external temperature variations of the high-temperature resistant cable body 1, and reduces damage to the high-temperature resistant cable body 1 caused by overheating. This configuration ensures the service life of the high-temperature resistant cable body 1 while promoting the operational stability and safety of the high-temperature resistant cable body 1 in high-temperature environments. Furthermore, targeted regulation of the liquid cooling circulation for the high-temperature resistant cable body 1 is achieved based on overheating factors. This promotes the heat dissipation effect, reduces damage caused by temperature to the high-temperature resistant cable body 1, provides effective overheat protection, and also effectively reduces energy consumption, enhancing the environmental friendliness of the high-temperature resistant cable body 1 in application. Furthermore, the separate liquid cooling effects further enhance the heat dissipation performance.

It is to be noted that the liquid cooling circulation structure is prior art. This embodiment directly incorporates the liquid cooling circulation structure without making any changes to its principle or structure. For example, the liquid cooling circulation structure includes components such as a circulation pump, a coolant storage tank, and a heat exchanger. A person skilled in the art can procure and select these components according to actual requirements, which will not be elaborated here. A stiffness coefficient of the outer heat sensing sleeve 2 is equal to a stiffness coefficient of the inner heat sensing sleeve 4. The stiffness coefficient of the outer heat sensing sleeve 2 is less than stiffness coefficients of the outer liquid cooling layer 12 and the protective outer layer 11. Consequently, when a thermal expansion effect is generated in the outer thermal deformation cavity 21, this thermal expansion effect first causes the bidirectional isolation sleeve 3 to act on the inner heat sensing sleeve 4, driving the inner heat sensing sleeve 4 to deform. The stiffness coefficient of the inner heat sensing sleeve 4 is less than stiffness coefficients of the inner liquid cooling layer 13, the isolation layer 14, and the cable core 15. Consequently, when a thermal expansion effect is generated in the inner thermal deformation cavity 41, this thermal expansion effect first causes the bidirectional isolation sleeve 3 to act on the outer heat sensing sleeve 2, driving the outer heat sensing sleeve 2 to deform.

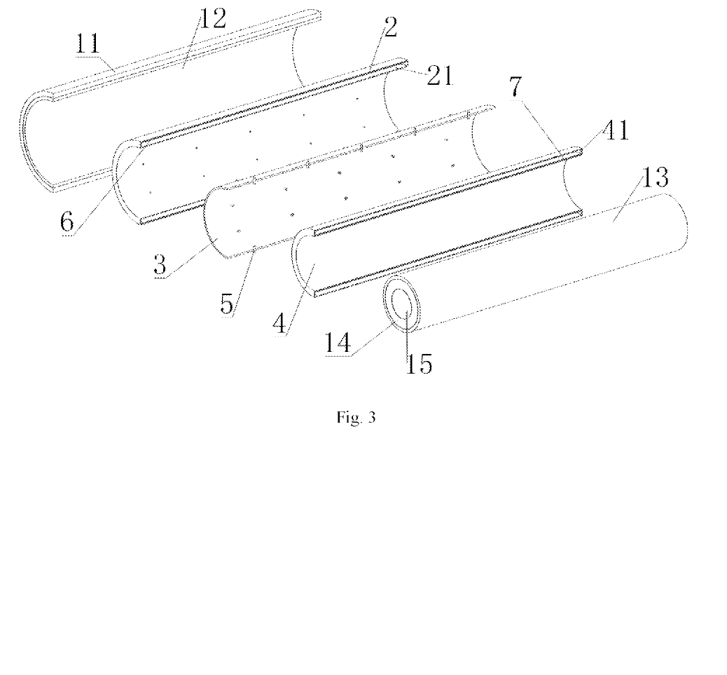

FIGS. 3 to 9 show that an outer thermal deformation cavity 21 is formed in the outer heat sensing sleeve 2, an outer triggering patch 6 is fixedly connected to an inner wall on a side of the outer thermal deformation cavity 21 away from the cable core 15, the outer triggering patch 6 is configured to cooperate with one end of each of the triggering posts 5 away from the cable core 15, and the input end of the inner end triggering acquisition unit is in signal communication with the outer triggering patch 6. Through the cooperation of the triggering posts 5 and the outer triggering patch 6, a thermal sensing state of the inner heat sensing sleeve 4 can be triggered and transmitted. This facilitates enhanced heat dissipation circulation effectiveness of the inner liquid cooling layer 13 when an overheating problem occurs inside the high-temperature resistant cable body 1 due to operation of the cable core 15, thereby achieving overheat protection for the cable core 15. This configuration reduces communication damage and operational instability caused by high temperature, ensuring operational safety of the high-temperature resistant cable body 1.

FIGS. 3 to 9 show that an inner thermal deformation cavity 41 is formed in the inner heat sensing sleeve 4, an inner triggering patch 7 is fixedly connected to an inner wall on a side of the inner thermal deformation cavity 41 close to the cable core 15, the inner triggering patch 7 is configured to cooperate with one end of each of the triggering posts 5 close to the cable core 15, and the input end of the outer end triggering acquisition unit is in signal communication with the inner triggering patch 7. Through the cooperation of the triggering posts 5 and the inner triggering patch 7, a thermal sensing state of the outer heat sensing sleeve 2 can be triggered and transmitted. This facilitates enhanced heat dissipation circulation effectiveness of the outer liquid cooling layer 12 when an excessively high temperature occurs externally to the high-temperature resistant cable body 1, thereby achieving overheat protection for the high-temperature resistant cable body 1 and providing an effective temperature barrier. This configuration avoids damage to the high- temperature resistant cable body 1 caused by continuous heat conduction. Furthermore, this configuration enables rational and efficient utilization of the liquid cooling circulation efficiency of the outer liquid cooling layer 12 and the inner liquid cooling layer 13. While ensuring operational stability of the high-temperature resistant cable body 1, this configuration reduces energy consumption, lowers heat dissipation maintenance costs, improves the green environmental performance of the high-temperature resistant cable body 1 operation, enhances the high-temperature resistance of the high-temperature resistant cable body 1, and promotes the economic benefits of the high-temperature resistant cable body 1 application.

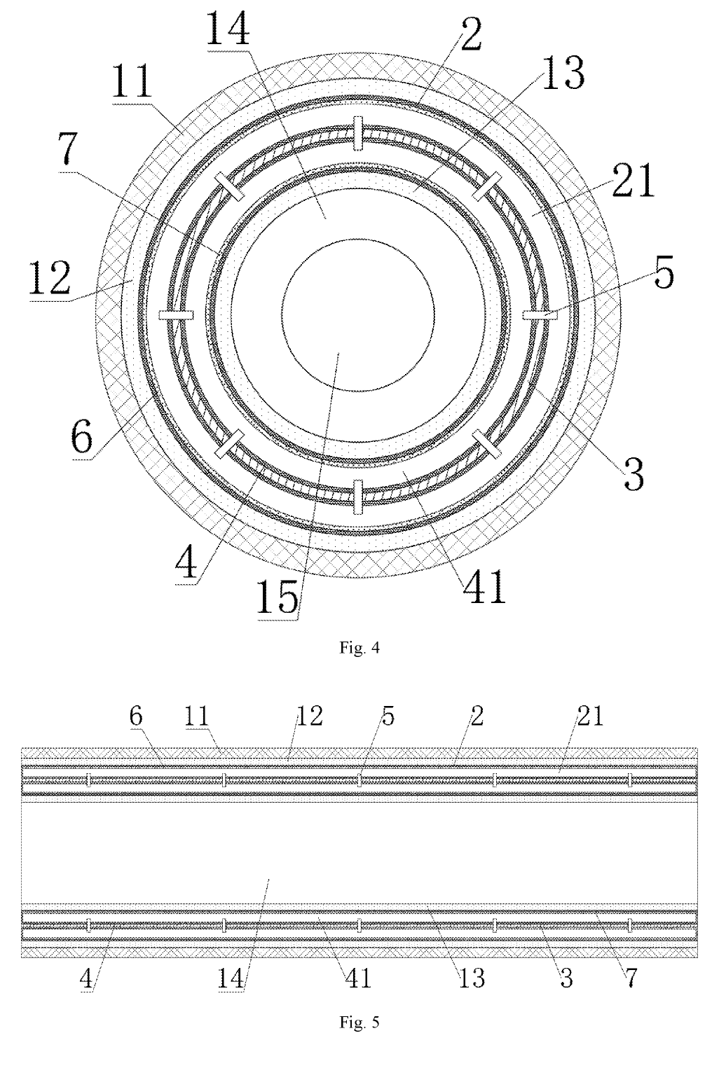

FIGS. 4 to 9 show that the outer thermal deformation cavity 21 is filled with an outer thermal deformation medium, and at normal temperature, the fill level of the outer thermal deformation medium in the outer thermal deformation cavity 21 is 50% to 60%. FIGS. 4 to 9 show that the inner thermal deformation cavity 41 is filled with an inner thermal deformation medium, and at normal temperature, the fill level of the inner thermal deformation medium in the inner thermal deformation cavity 41 is 50% to 60%. The outer thermal deformation medium and the inner thermal deformation medium are inert gases with thermal expansion properties. The outer thermal deformation medium and the inner thermal deformation medium are capable of generating a thermal expansion deformation effect while also protecting the application safety of the high-temperature resistant cable body 1. The half-saturation filling method also effectively promotes the effectiveness of the deformation sensing of the outer heat sensing sleeve 2 and the inner heat sensing sleeve 4, ensuring the safety of the thermal deformation triggering.

FIGS. 1 to 9 show that before application of the high-temperature resistant cable body 1, a cable technician inputs parameter data related to the high-temperature resistant cable body 1 at that time into the cable parameter acquisition unit through a signal input port on the heat-resistant cable maintenance station 9. The parameter data includes, but is not limited to, a wire diameter of the high-temperature resistant cable body 1, application environment data of the high-temperature resistant cable body 1, and a rated application temperature. Simultaneously, the cable technician inputs data related to liquid cooling into the liquid cooling parameter acquisition unit. The liquid cooling data includes, but is not limited to, circulation space data of the outer liquid cooling layer 12 and the inner liquid cooling layer 13, a rated power of the liquid cooling circulation structure, a daily operating power, and an overheat protection operating power. The cable parameter acquisition unit and the liquid cooling parameter acquisition unit transmit these basic data to the heat-resistant protection processing unit. The heat-resistant protection processing unit analyzes and processes these data.

Then, during application of the high-temperature resistant cable body 1, the heat-resistant protection processing unit, according to parameter settings, transmits a liquid cooling regulation signal to the liquid cooling adjustment unit. The liquid cooling adjustment unit controls the liquid cooling circulation structure to operate, so that a circulating cooling effect is generated within the outer liquid cooling layer 12 and the inner liquid cooling layer 13. The circulating cooling effect is capable of absorbing heat from the exterior and interior of the high-temperature resistant cable body 1, thereby ensuring application stability of the high-temperature resistant cable body 1 in high-temperature environments, promoting the high-temperature resistance of the high-temperature resistant cable body 1, and reducing communication damage to the high-temperature resistant cable body 1 caused by high temperature.

When no temperature change occurs internally or externally to the high-temperature resistant cable body 1, the liquid cooling circulation of the outer liquid cooling layer 12 and the inner liquid cooling layer 13 can effectively achieve heat dissipation and cooling for the high-temperature resistant cable body 1. Consequently, under this condition, the outer thermal deformation medium in the outer thermal deformation cavity 21 of the outer heat sensing sleeve 2 and the inner thermal deformation medium in the inner thermal deformation cavity 41 of the inner heat sensing sleeve 4 do not generate significant deformation. Further, under the elastic force maintenance action of the outer heat sensing sleeve 2 and the inner heat sensing sleeve 4, the outer heat sensing sleeve 2 and the inner heat sensing sleeve 4 attain an equilibrium state. This equilibrium state causes the bidirectional isolation sleeve 3 and the triggering posts 5 to remain in a central position between the outer heat sensing sleeve 2 and the inner heat sensing sleeve 4. Consequently, the bidirectional isolation sleeve 3 and the triggering posts 5 do not contact the outer triggering patch 6 or the inner triggering patch 7. This condition indicates satisfactory heat dissipation status, allowing operational stability and safety of the high-temperature resistant cable body 1 to be maintained with relatively low circulation power, thereby reducing energy consumption and waste.

When a high-temperature change occurs in the external environment of the high-temperature resistant cable body 1, the outer thermal deformation medium in the outer thermal deformation cavity 21 of the outer heat sensing sleeve 2 continuously absorbs heat and subsequently generates thermal expansion. This thermal expansion acts on the outer thermal deformation cavity 21, causing thermal expansion deformation. Consequently, the elastic deformation of the outer heat sensing sleeve 2 applies a compressive force to the bidirectional isolation sleeve 3 and also applies a compressive force to the inner heat sensing sleeve 4. As the bidirectional isolation sleeve 3 continuously moves closer to the inner heat sensing sleeve 4 and applies a compressive, contracting force to the inner heat sensing sleeve 4, the end of each of the triggering posts 5 close to the cable core 15 abuts against and contacts the inner triggering patch 7. Then, the outer end triggering acquisition unit receives the trigger signal transmitted from the inner triggering patch 7 and transmits the trigger signal to the heat-resistant protection processing unit. The heat-resistant protection processing unit determines that the external temperature of the high-temperature resistant cable body 1 has increased and then issues a control command to the liquid cooling adjustment unit. The liquid cooling adjustment unit controls the liquid cooling circulation structure to act on the outer liquid cooling layer 12, increasing the circulation efficiency of the coolant within the outer liquid cooling layer 12. This action enhances the heat dissipation effect on the outer portion of the high-temperature resistant cable body 1, effectively blocks the transmission of external temperature, and ensures the operational stability of the high-temperature resistant cable body 1.

When a high-temperature change occurs internally within the high-temperature resistant cable body 1 due to operation or other factors, the inner thermal deformation medium in the inner thermal deformation cavity 41 of the inner heat sensing sleeve 4 continuously absorbs heat and subsequently generates thermal expansion. This thermal expansion drives the inner thermal deformation cavity 41 to undergo thermal expansion deformation. Consequently, the elastic deformation of the inner heat sensing sleeve 4 acts on the bidirectional isolation sleeve 3, so that the bidirectional isolation sleeve 3 continuously moves closer to the outer heat sensing sleeve 2 and applies a compressive force to the outer heat sensing sleeve 2. During the process where the bidirectional isolation sleeve 3 continuously compresses the outer heat sensing sleeve 2, the outer heat sensing sleeve 2 continuously contracts, so that the end of each of the triggering posts 5 away from the cable core 15 abuts against and contacts the outer triggering patch 6. Then, the inner end triggering acquisition unit receives the trigger signal transmitted from the outer triggering patch 6 and transmits the trigger signal to the heat-resistant protection processing unit. The heat-resistant protection processing unit determines that the internal temperature of the high-temperature resistant cable body 1 has increased and then issues a control command to the liquid cooling adjustment unit. The liquid cooling adjustment unit controls the liquid cooling circulation structure to act on the inner liquid cooling layer 13, increasing the circulation efficiency of the coolant within the inner liquid cooling layer 13. This action enhances the heat dissipation effect inside the high-temperature resistant cable body 1, reduces damage to the cable core 15 caused by temperature, ensures the effectiveness and stability of signal transmission operation of the cable core 15, and prevents communication fluctuations caused by temperature increase.

During the process where the heat-resistant protection processing unit performs operational protection and overheat protection for the high-temperature resistant cable body 1, the heat-resistant protection processing unit transmits the control data from the protection process to the protection data transmission unit. The protection data transmission unit outputs the control data through the signal output port of the heat-resistant cable maintenance station 9. This output facilitates technicians and maintenance personnel in reviewing status data and protection data of the high-temperature resistant cable body 1. The output data facilitates technicians in making adaptive improvements to the high-temperature resistant cable body 1 and the liquid cooling program, promoting the safety and effectiveness of the high-temperature resistant cable body 1 application. The output data facilitates maintenance personnel in assessing the status of the high-temperature resistant cable body 1 based on the data, enabling maintenance personnel to implement effective maintenance measures and actions, thereby providing safety assurance for the high-temperature resistant cable body 1.

### Embodiment 2

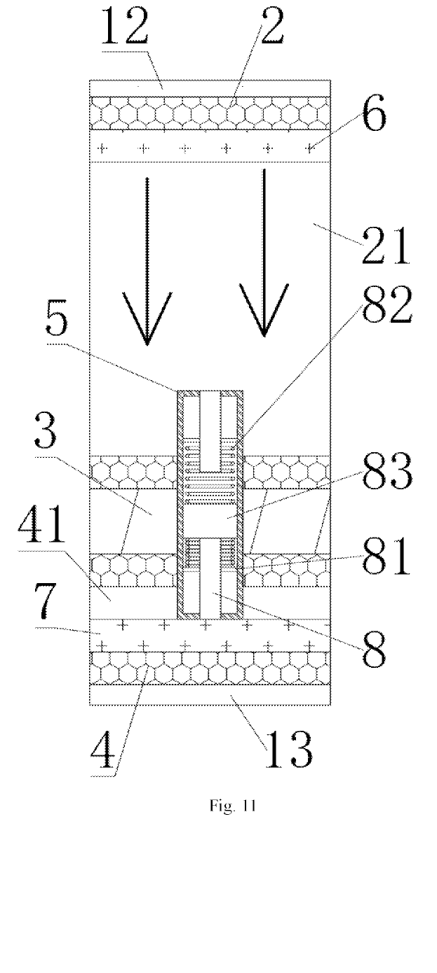

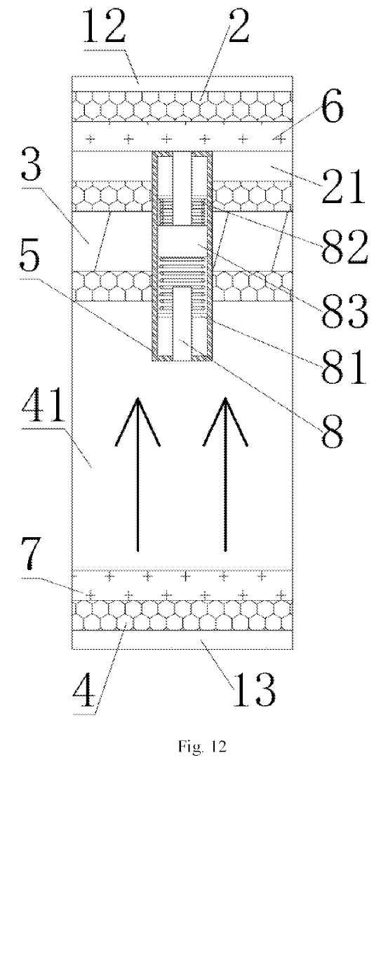

FIGS. 1 to 12 show an overheat protection type high-temperature resistant cable. As a further improvement and addition to the functions of Embodiment 1, and as an optional feature to further enhance the intelligence of Embodiment 1, this embodiment increases the versatility and demand adaptability of Embodiment 1. A buffer sensing cavity is formed in each of the triggering posts 5, a triggering core block 83 is fixedly connected to a middle portion of the buffer sensing cavity, an overheating conduction post 8 is embedded in each of an inner wall of the buffer sensing cavity close to the cable core 15 and an inner wall of the buffer sensing cavity away from the cable core 15, and ends of the two overheating conduction posts 8 close to each other extend into the buffer sensing cavity and are configured to cooperate with the triggering core block 83. The arrangement of the overheating conduction posts 8 and the triggering core block 83 enables sensing and detecting the triggering status of the triggering posts 5. This arrangement effectively enables verification of the effectiveness of the overheat protection measures, ensures the adjustment and effectiveness of the overheat protection, further ensures the operational stability and safety of the high-temperature resistant cable body 1, also promotes the automation and intelligence of the heat-resistant protection system, improves the maintenance effectiveness of the heat-resistant protection system for the high-temperature resistant cable body 1, and promotes the self-inspection and self-adjustment functions of the heat-resistant protection system.

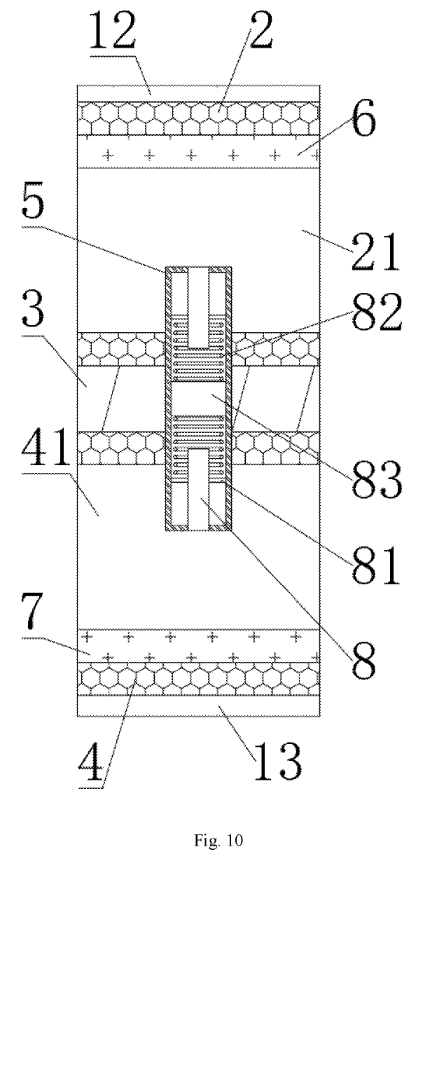

FIGS. 10 to 12 show that an outer end of each of the overheating conduction posts 8 is fixedly connected to a retaining ring 81 located in the buffer sensing cavity, the retaining ring 81 is slidably engaged with an inner wall of the buffer sensing cavity, one end of the retaining ring 81 close to the triggering core block 83 is fixedly connected to an elastic reset element 82 sleeved on an outer side of each of the overheating conduction posts 8, and one end of the elastic reset element 82 close to the triggering core block 83 is fixedly connected to the triggering core block 83. The arrangement of the retaining ring 81 and the elastic reset element 82 enhances the reset action of the overheating conduction post 8 and the triggering core block 83 after triggering. While ensuring the effectiveness and sensitivity of the trigger verification, this arrangement also reduces the manufacturing cost of the high-temperature resistant cable body 1 through mechanical reset, thereby promoting the economic benefits of the high-temperature resistant cable body 1.

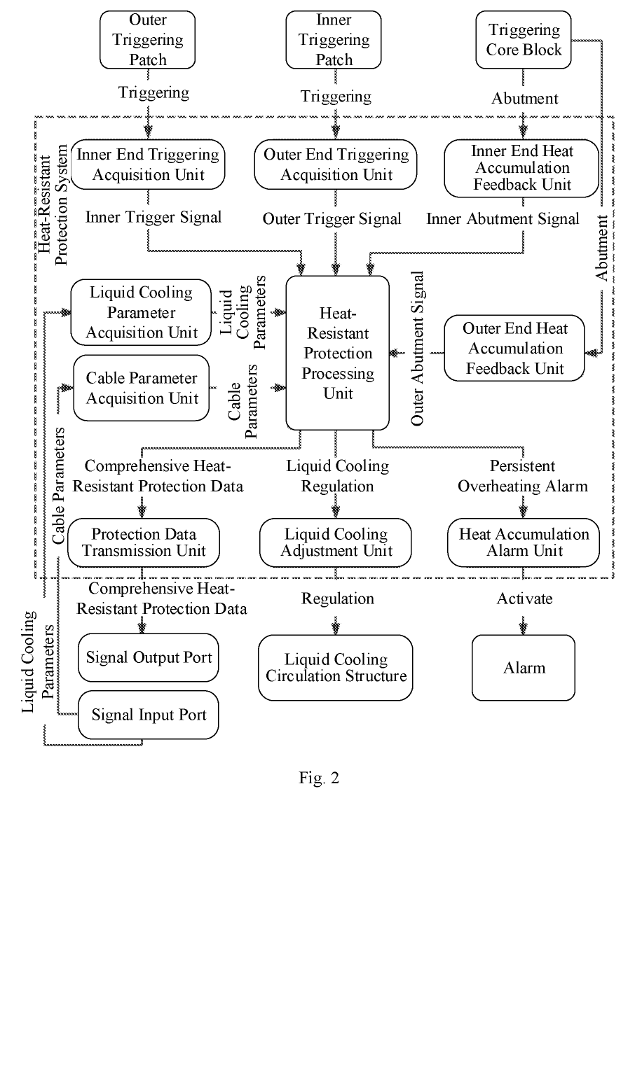

FIGS. 2 and 10 to 12 show that the input end of the heat-resistant protection processing unit is further connected to an inner end heat accumulation feedback unit and an outer end heat accumulation feedback unit, respective input ends of the inner end heat accumulation feedback unit and the outer end heat accumulation feedback unit are in signal communication with the triggering core block 83, the output end of the heat-resistant protection processing unit is connected to a heat accumulation alarm unit, and an output end of the heat accumulation alarm unit is in signal communication with an alarm provided on the heat-resistant cable maintenance station 9. The cooperation of the inner end heat accumulation feedback unit and the outer end heat accumulation feedback unit provides further overheat protection, heat dissipation verification, and persistent overheating warning for the high-temperature resistant cable body 1. This cooperation effectively ensures the operational stability and safety of the high-temperature resistant cable body 1, assists maintenance personnel and relevant technicians in promptly addressing overheating anomalies of the high-temperature resistant cable body 1, and reduces economic losses caused by persistent overheating.

FIGS. 1 to 12 show that when a high-temperature change occurs in the external environment and the heat-resistant protection processing unit controls the liquid cooling adjustment unit based on data transmitted from the outer end triggering acquisition unit, if the overheat protection control is effective, the temperature of the outer heat sensing sleeve 2 continuously recovers. This temperature recovery causes the outer thermal deformation medium in the outer thermal deformation cavity 21 to undergo a volume recovery change, releasing the thermal expansion effect on the outer thermal deformation cavity 21. Under the elastic recovery action of the outer heat sensing sleeve 2 and the inner heat sensing sleeve 4, the bidirectional isolation sleeve 3 and the inner heat sensing sleeve 4 gradually undergo recovery deformation. Each of the triggering posts 5 moves away from the inner triggering patch 7. The outer end triggering acquisition unit no longer receives the outer trigger signal and transmits this status to the heat-resistant protection processing unit. The heat-resistant protection processing unit determines that the overheat protection control is effective at this time. Then, after the liquid cooling circulation structure has acted on the outer liquid cooling layer 12 for a period of time, the heat-resistant protection processing unit issues a liquid cooling restoration adjustment command to the liquid cooling adjustment unit. The liquid cooling adjustment unit controls the liquid cooling circulation structure to restore the liquid cooling circulation power of the outer liquid cooling layer 12 to the normal liquid cooling state. Then, based on subsequent signals transmitted from the outer end triggering acquisition unit, the heat-resistant protection processing unit determines the recovery status of the external environment of the high-temperature resistant cable body 1. When the aforementioned overheat protection operation cycle occurs multiple times consecutively during subsequent application of the high-temperature resistant cable body 1, the heat-resistant protection processing unit issues an alarm signal to the heat accumulation alarm unit. The heat accumulation alarm unit activates the alarm on the heat-resistant cable maintenance station 9, issuing an alarm alert to maintenance personnel, reminding maintenance personnel to inspect and maintain the application of the high-temperature resistant cable body 1, thereby ensuring the safety of subsequent application of the high-temperature resistant cable body 1.

If the overheat protection control is ineffective, the outer heat sensing sleeve 2 maintains persistent thermal expansion under the action of the outer thermal deformation medium and applies further compressive force to the bidirectional isolation sleeve 3 and the inner heat sensing sleeve 4. Under these conditions, the end of each of the triggering posts 5 close to the cable core 15, under the abutting action of the inner triggering patch 7, applies a compressive force to the overheating conduction posts 8 located inside the triggering posts 5. This compressive force causes the elastic reset element 82 to be compressed under the action of the retaining ring 81. The other end of each of the overheating conduction posts 8 abuts against the triggering core block 83. The outer end heat accumulation feedback unit then receives the abutting signal from the side of the triggering core block 83 close to the cable core 15 and transmits the data to the heat-resistant protection processing unit. The heat-resistant protection processing unit determines that the external temperature change of the high-temperature resistant cable body 1 is abnormal at this time and then transmits the persistent overheating abnormal alarm data to the heat accumulation alarm unit. The heat accumulation alarm unit activates the alarm on the heat-resistant cable maintenance station 9, issuing an alarm alert to maintenance personnel and prompting them to take emergency response measures. Simultaneously, the heat-resistant protection processing unit also issues a persistent enhanced liquid cooling regulation command to the liquid cooling adjustment unit, so that the liquid cooling adjustment unit controls the liquid cooling circulation structure to act on the outer liquid cooling layer 12, further increasing the heat absorption circulation effect of the outer liquid cooling layer 12, buying valuable time for maintenance personnel’s emergency repair and inspection, thereby effectively reducing economic losses.

When a temperature change occurs in the internal environment and the heat-resistant protection processing unit controls the liquid cooling adjustment unit based on data transmitted from the outer end triggering acquisition unit, if the overheat protection control is effective, the temperature of the inner heat sensing sleeve 4 continuously recovers. This temperature recovery causes the inner thermal deformation medium in the inner thermal deformation cavity 41 to undergo a volume recovery change, releasing the thermal expansion effect on the inner thermal deformation cavity 41. Under the elastic recovery action of the outer heat sensing sleeve 2 and the inner heat sensing sleeve 4, the bidirectional isolation sleeve 3 and the outer heat sensing sleeve 2 gradually undergo recovery deformation. Each of the triggering posts 5 moves away from the outer triggering patch 6. The inner end triggering acquisition unit no longer receives the inner trigger signal and transmits this status to the heat-resistant protection processing unit. The heat-resistant protection processing unit determines that the overheat protection control is effective at this time. Then, after the liquid cooling circulation structure has acted on the inner liquid cooling layer 13 for a period of time, the heat-resistant protection processing unit issues a liquid cooling restoration adjustment command to the liquid cooling adjustment unit. The liquid cooling adjustment unit controls the liquid cooling circulation structure to restore the liquid cooling circulation power of the inner liquid cooling layer 13 to the normal liquid cooling state. Then, based on subsequent signals transmitted from the inner end triggering acquisition unit, the heat-resistant protection processing unit determines the recovery status of the internal environment of the high-temperature resistant cable body 1. When the aforementioned overheat protection operation cycle occurs multiple times consecutively during subsequent application of the high-temperature resistant cable body 1, the heat-resistant protection processing unit issues an alarm signal to the heat accumulation alarm unit. The heat accumulation alarm unit activates the alarm on the heat-resistant cable maintenance station 9, issuing an alarm alert to maintenance personnel, reminding maintenance personnel to inspect and maintain the application of the high-temperature resistant cable body 1, and to check whether the high-temperature resistant cable body 1 is overloaded, ensuring the safety of subsequent application of the high-temperature resistant cable body 1.

If the overheat protection control is ineffective, the inner heat sensing sleeve 4 maintains persistent thermal expansion under the action of the inner thermal deformation medium and applies further compressive force to the bidirectional isolation sleeve 3 and the outer heat sensing sleeve 2. Under these conditions, the end of each of the triggering posts 5 away from the cable core 15, under the abutting action of the outer triggering patch 6, applies a compressive force to the overheating conduction posts 8 located inside the triggering posts 5. This compressive force causes the elastic reset element 82 to be compressed under the action of the retaining ring 81. The other end of each of the overheating conduction posts 8 abuts against the triggering core block 83. The inner end heat accumulation feedback unit then receives the abutting signal from the side of the triggering core block 83 close to the cable core 15 and transmits the data to the heat-resistant protection processing unit. The heat-resistant protection processing unit determines that the internal temperature change of the high-temperature resistant cable body 1 is abnormal at this time and then transmits the persistent overheating abnormal alarm data to the heat accumulation alarm unit. The heat accumulation alarm unit activates the alarm on the heat-resistant cable maintenance station 9, issuing an alarm alert to maintenance personnel and prompting them to take emergency response measures. Simultaneously, the heat-resistant protection processing unit also issues a persistent enhanced liquid cooling regulation command to the liquid cooling adjustment unit, so that the liquid cooling adjustment unit controls the liquid cooling circulation structure to act on the inner liquid cooling layer 13, further increasing the heat absorption circulation effect of the inner liquid cooling layer 13, buying valuable time for maintenance personnel’s emergency repair and inspection, thereby effectively reducing economic losses.

Based on current practical requirements, the protection scope of the above embodiments adopted in the present disclosure is not limited thereto. Various changes made without departing from the concept of the present disclosure, within the knowledge scope of those skilled in the art, still fall within the protection scope of the present disclosure.

1. An overheat protection type high-temperature resistant cable, comprising a high-temperature resistant cable body and a heat-resistant cable maintenance station configured to cooperate with the high-temperature resistant cable body, wherein the high-temperature resistant cable body comprises a cable core, an isolation layer fixedly sleeved on an outer end of the cable core, an inner liquid cooling layer fixedly sleeved on an outer end of the isolation layer, an outer liquid cooling layer disposed on an outer side of the inner liquid cooling layer, and a protective outer layer fixedly sleeved on an outer end of the outer liquid cooling layer;
an inner heat sensing sleeve is fixedly sleeved on an outer end of the inner liquid cooling layer, a bidirectional isolation sleeve is fixedly sleeved on an outer end of the inner heat sensing sleeve, an outer heat sensing sleeve is fixedly sleeved on an outer end of the bidirectional isolation sleeve, and an outer end of the outer heat sensing sleeve is fixedly connected to the outer liquid cooling layer; a plurality of triggering posts are embedded in the bidirectional isolation sleeve, each of the triggering posts has one end away from the cable core extending into the outer heat sensing sleeve and configured to cooperate with the outer heat sensing sleeve; and each of the triggering posts has another end close to the cable core extending into the inner heat sensing sleeve and configured to cooperate with the inner heat sensing sleeve;
a heat-resistant protection system is provided in the heat-resistant cable maintenance station, the heat-resistant protection system comprises a heat-resistant protection processing unit, an input end of the heat-resistant protection processing unit is connected to an inner end triggering acquisition unit, an outer end triggering acquisition unit, a liquid cooling parameter acquisition unit, and a cable parameter acquisition unit, and an output end of the heat-resistant protection processing unit is connected to a liquid cooling adjustment unit and a protection data transmission unit; and
an input end of the inner end triggering acquisition unit is in signal communication with the outer heat sensing sleeve, an input end of the outer end triggering acquisition unit is in signal communication with the inner heat sensing sleeve, respective input ends of the liquid cooling parameter acquisition unit and the cable parameter acquisition unit are each in signal communication with a signal input port provided on the heat-resistant cable maintenance station, an output end of the liquid cooling adjustment unit is in signal communication with a liquid cooling circulation structure provided at a rear side of the heat-resistant cable maintenance station, the liquid cooling circulation structure is in communication with and configured to cooperate with the outer liquid cooling layer and the inner liquid cooling layer respectively, and an output end of the protection data transmission unit is in signal communication with a signal output port provided on the heat-resistant cable maintenance station.

2. The overheat protection type high-temperature resistant cable according to claim 1, wherein a buffer sensing cavity is formed in each of the triggering posts, a triggering core block is fixedly connected to a middle portion of the buffer sensing cavity, an overheating conduction post is embedded in each of an inner wall of the buffer sensing cavity close to the cable core and an inner wall of the buffer sensing cavity away from the cable core, and ends of the two overheating conduction posts close to each other extend into the buffer sensing cavity and are configured to cooperate with the triggering core block.

3. The overheat protection type high-temperature resistant cable according to claim 2, wherein an outer end of each of the overheating conduction posts is fixedly connected to a retaining ring located in the buffer sensing cavity, the retaining ring is slidably engaged with an inner wall of the buffer sensing cavity, one end of the retaining ring close to the triggering core block is fixedly connected to an elastic reset element sleeved on an outer side of each of the overheating conduction posts, and one end of the elastic reset element close to the triggering core block is fixedly connected to the triggering core block.

4. The overheat protection type high-temperature resistant cable according to claim 2, wherein the input end of the heat-resistant protection processing unit is further connected to an inner end heat accumulation feedback unit and an outer end heat accumulation feedback unit, respective input ends of the inner end heat accumulation feedback unit and the outer end heat accumulation feedback unit are in signal communication with the triggering core block, the output end of the heat-resistant protection processing unit is connected to a heat accumulation alarm unit, and an output end of the heat accumulation alarm unit is in signal communication with an alarm provided on the heat-resistant cable maintenance station.

5. The overheat protection type high-temperature resistant cable according to claim 1, wherein an outer thermal deformation cavity is formed in the outer heat sensing sleeve, an outer triggering patch is fixedly connected to an inner wall on a side of the outer thermal deformation cavity away from the cable core, the outer triggering patch is configured to cooperate with one end of each of the triggering posts away from the cable core, and the input end of the inner end triggering acquisition unit is in signal communication with the outer triggering patch.

6. The overheat protection type high-temperature resistant cable according to claim 5, wherein the outer thermal deformation cavity is filled with an outer thermal deformation medium, and at normal temperature, a fill level of the outer thermal deformation medium in the outer thermal deformation cavity is 50% to 60%.

7. The overheat protection type high-temperature resistant cable according to claim 1, wherein an inner thermal deformation cavity is formed in the inner heat sensing sleeve, an inner triggering patch is fixedly connected to an inner wall on a side of the inner thermal deformation cavity close to the cable core, the inner triggering patch is configured to cooperate with one end of each of the triggering posts close to the cable core, and the input end of the outer end triggering acquisition unit is in signal communication with the inner triggering patch.

8. The overheat protection type high-temperature resistant cable according to claim 7, wherein the inner thermal deformation cavity is filled with an inner thermal deformation medium, and at normal temperature, a fill level of the inner thermal deformation medium in the inner thermal deformation cavity is 50% to 60%.
